(19) United States
(12) Patent Application Publication
(10) Pub. No.: US 2021/0036553 A1
(43) Pub. Date: Feb. 4, 2021

(54) Inductive Power Transfer

(71) Applicant: Apple Inc., Cupertino, CA (US)

(72) Inventors: Aiguo Hu, Auckland (NZ); Jeffrey Douglas Louis, Auckland (NZ); Geoff Chisholm, Auckland (NZ); Duleepa Thrimawithana, Auckland (NZ); Lei Zhao, Auckland (NZ); Yunyu Tang, Auckland (NZ); Udaya Madawala, Auckland (NZ)

(21) Appl. No.: 16/990,445

(22) Filed: Aug. 11, 2020

Related U.S. Application Data
(62) Division of application No. 15/896,951, filed on Feb. 14, 2018.
(60) Provisional application No. 62/458,929, filed on Feb. 14, 2017.

(51) Int. Cl. H02J 50/12; H01F 27/38; H01F 38/14

(52) U.S. Cl. CPC H02J 50/12; H01F 38/14; H01F 27/38

(57) ABSTRACT

An inductive power transfer device for transmitting or receiving magnetic flux, the device comprising two co-planar and adjacent coils defining respective apertures and having a magnetically permeable core located to at least partially overlap both apertures; the two co-planar coils together defining a shape which is substantially equally extended in orthogonal directions.

### FIELD

The present invention relates to inductive power transfer.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

The term ‘inverter’ may sometimes be used to describe a DC-AC converter specifically. Again, such inverters may include other conversion stages, or an inverter may be a stage in the context of a more general converter. Therefore, the term inverter should be interpreted to encompass DC-AC converters, either in isolation or in the context of a more general converter. For the sake of clarity, the remainder of this specification will refer to the DC-AC converter of the invention by the term ‘inverter’ without excluding the possibility that the term ‘converter’ might be a suitable alternative in some situations.

One example of the use of inverters is in inductive power transfer (IPT) systems. IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

So-called double D or “DD” coils driven in anti-phase are known to generate a magnetic field having enhanced flux density at greater height above the coils (improved z) compared to such coils driven in phase. Such DD coils are disclosed in WO2013036146 to Auckland Uniservices Limited, the disclosure of which is incorporated by reference. So called DD quadrature coils or “DDQ” coils consist of a pair of DD coils with a further coil positioned across the DD coils. DD coils may be used advantageously as transmitter coils with DDQ coils used as receiver coils in applications such as electric vehicle charging where good coupling over large coil separation is desirable.

It would be desirable to utilize the improved z provided by DD coils driven in antiphase in other applications. DD coils also reduce the amount of flux available for stray coupling to foreign objects (that are beside, but not under the receiver), reducing the likelihood of charging being disabled due to foreign object detection.

### SUMMARY

The present invention provides improved inductive power transfer or at least seeks to provide the public a useful choice.

According to one exemplary embodiment there is provided an inductive power transmitter or receiver as claimed in any of the appended claims.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any document in this specification does not constitute an admission that such document is prior art, that it forms part of the common general knowledge or that it is validly combinable with other documents.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a block diagram of an inductive power transfer system;

FIG. 2a is a schematic diagram of a DD type coil;

FIG. 2b is a circuit diagram of a transmitter implementation;

FIG. 2c is a schematic diagram of a transmitter implementation;

FIG. 3 is a schematic diagram of a DDQ type coil;

FIGS. 4-6 are graphs of experimental results;

FIG. 7 is a circuit diagram of a prototype circuit;

FIGS. 8-11 are schematic diagrams of the coverage zones of a planar array of DD coils;

FIG. 12 is a circuit diagram of a transmitter and/or receiver implementation;

FIG. 13 is a circuit diagram of an alternative receiver implementation;

FIGS. 14a-14b are schematic diagrams of another coil arrangement;

FIGS. 15a-15b are graphs of simulated results for an inductive power system utilising the circuit of FIG. 12;

FIGS. 16a-16e are graphs of experimental results for an inductive power system utilising the circuit of FIG. 12;

FIGS. 17a-17d are graphs of experimental results for an inductive power system utilising the circuit of FIG. 12; and

FIGS. 18a-18f are graphs of experimental results for an inductive power system utilising the circuit of FIG. 12.

### DETAILED DESCRIPTION

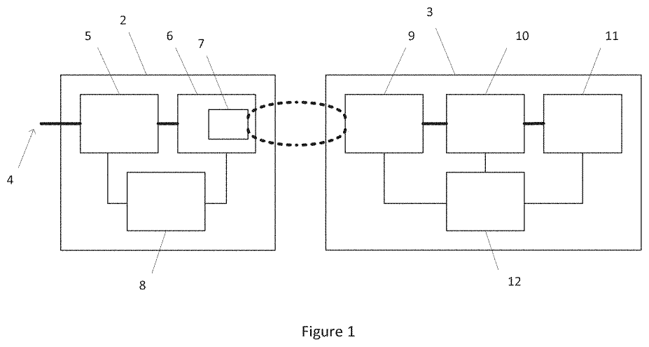

An IPT system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the converter 5. The transmitting coil or coils 7 may be connected to capacitors (not shown) either in parallel or series to create a resonant circuit. Additional coils may be provided, for example in an LCL configuration.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energizing transmitting coils, inductive power receiver detection and/or communications.

The inductive power receiver 3 includes a power pick up stage 9 connected to power conditioning circuitry 10 that in turn supplies power to a load 11. The power pick up stage 9 includes inductive power receiving coil or coils. When the coils of the inductive power transmitter 2 and the inductive power receiver 3 are suitably coupled, the alternating magnetic field generated by the transmitting coil or coils 7 induces an alternating current in the receiving coil or coils. The receiving coil or coils may be connected to capacitors (not shown) either in parallel or series to create a resonant circuit. Additional coils may be provided, for example in an LCL configuration.

In some inductive power receivers, the receiver may include a controller 12 which may control tuning of the receiving coil or coils, operation of the power conditioning circuitry 10 and/or communications.

The term “coil” may include an electrically conductive structure where an electrical current generates a magnetic field. For example, inductive “coils” may be electrically conductive wire wound in three dimensional shapes or two dimensional planar shapes, electrically conductive material fabricated using printed circuit board (PCB) techniques into three dimensional shapes over plural PCB ‘layers’, or using conductive printing and other coil-like shapes. Other configurations may be used depending on the application.

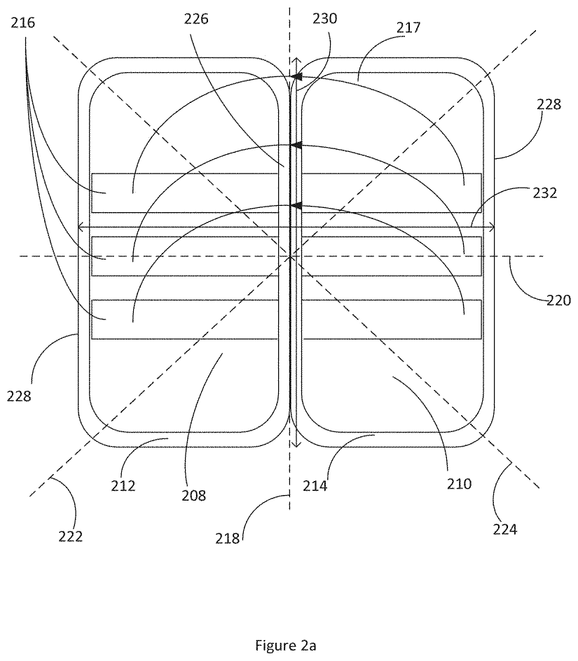

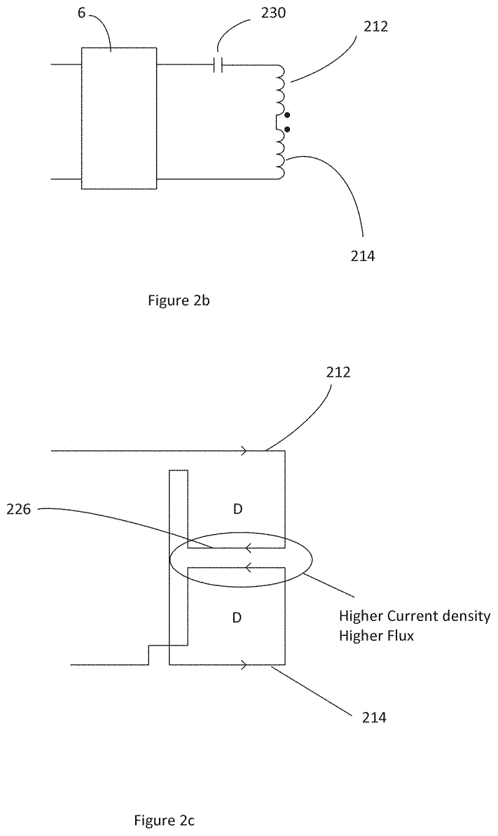

FIG. 2a shows a DD type coil charging pad 200 with two adjacent planar coils 212 and 214. The flux lines 217 illustrate the flux path when the coils 212 and 214 are driven in anti-phase such that the current direction at the adjacent winding portions is the same. This may be achieved by separate driving of the coils or more usually driven by the same signal but connected to ensure the same current direction at the adjacent winding portions. In an alternative arrangement the coils 212 and 214 may be driven with a different excitation configuration, such as in phase, depending on the application.

The charging pad 200 forms a “flux pipe”, being the paths formed by flux produced by the currents flowing in the adjacent winding portions. The flux pipe is formed to minimize the closed path length around those currents and minimizes the self-inductance and such that the adjacent winding portions are laid closely or sufficiently intimately spaced that these flux paths do not “leak” through the adjacent winding portions. Remembering that magnetic flux is produced perpendicular to the flow of electric current, the path of the flux pipe formed is thus perpendicular to the flow of current in the path of the adjacent winding portions. The flux pipe provides a generally elongate region of high flux concentration from which ideally no flux escapes. The flux pipe in this embodiment has a core 216 which includes a magnetically permeable material such as ferrite to attract flux to stay in the core. With electric circuits there is a large difference between the conductivity of conductors—typically 5.6×10⁷ S/m for copper; and air—in the order of 10⁻¹⁵ S/m—but this situation does not pertain with magnetic fields where the difference in permeability between ferrite and air is only the order of 3,000:1 or less. Thus, in magnetic circuits leakage flux in air or other non-magnetic materials is always present and this has to be controlled to get the best outcome.

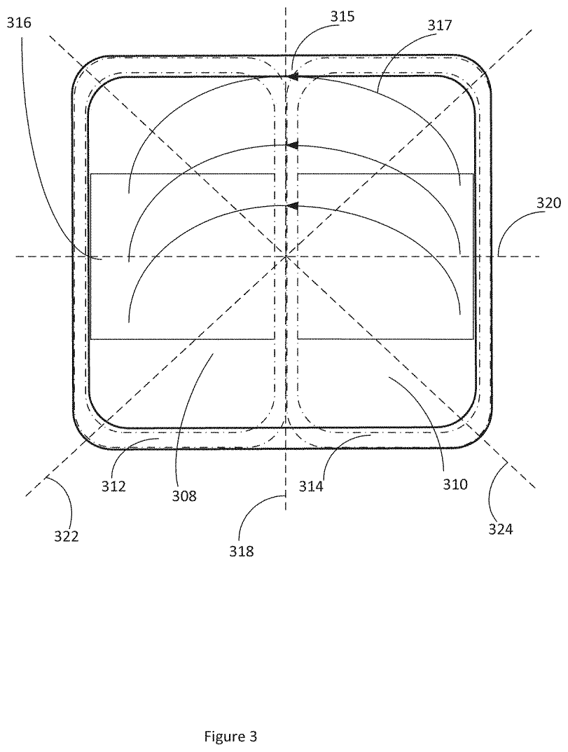

The core 216 may be a series of ferrite rods (as shown in FIG. 2a), or may be a ferrite sheet 316 (as shown in FIG. 3). It is generally planar and located immediately underneath the DD coils 212 and 214, and may extend from the outer portions 228 of each coil, or more generally at least into the apertures formed by the windings. Alternative it may be located to at least partially overlap both apertures; where partially means having a length which extends into the aperture by at least 1%, 5% or 20% of the total length of the core. The core 216 may extend beyond the coils, as this further reduces any leakage flux around the bottom of the pad but now since the flux pipe path contains all of the relevant linking or coupling flux with a receiver coil, “short-circuiting” of leakage flux produced by currents flowing outside the flux pipe is no longer of concern. A highly magnetically permeable (i.e., ferrite) core placed under the pad thus becomes a highly effective means of eliminating rearward or bottom-facing flux, for which metal shielding can even further attenuate if the magnetic core material is not sufficiently permeable or voluminous.

In contrast, a single circular coil's non-polarized flux paths near the outer circumference of the windings is often a compromise between keeping them close to the winding to reduce stray or foreign object interaction, and the z-axis height that those paths achieve over the aperture of the coil to link with a receiver coil. The DD pad however forms two separate flux paths, one: through the flux pipe and over the adjacent winding portions, and the other: around the non-adjacent winding portions (return paths for currents in the adjacent portions). These paths around the non-adjacent portions can thus be kept close to the winding by extending the ferrite core significantly past the edges of the windings. The reduction in z-height of these flux paths by extending the ferrite core is no longer a concern, since these flux paths are not relevant to linking with a receiver coil. Instead only the flux formed around the adjacent winding portions going through the flux pipe is relevant to coupling with a receiver coil, and is not negatively affected by extending the ferrite core beyond the edges of the windings, as happens with a single circular coil.

The DD coils 212 and 214 sit in a co-planar relationship in close proximity to each other on top of the core 216 to provide the flux pipe. There is no straight path through the flux pipe that passes through the coils 212 and 214. Instead, the arrangement of the coils 212 and 214 means that flux entering the pad through one of the first aperture 208 propagates through the first coil 212 into the core 216 from where it propagates along the core 216, then exits the pad out through the second aperture 210 and the second coil 214, and completes its path through air back to the first aperture 208 to form a complete curved flux path. The flux path so formed is essentially completely above a front or top surface of the pad and extends into a space beyond the front or top surface. The arrangement of coils 212 and 214 also means that there is essentially no flux extending beyond a rear face of the pad. Thus, the orientation of the coils 212 and 214 ensures that the flux path is directed in a curve out into a space in front of the front surface of the pad, and the spread or distributed nature of the coils 212 and 214 across the upper surface of the core 216 ensures that the flux in the center of the pad is primarily constrained within the core. The coils 212 and 214 also define the spaced apart pole areas so that the flux is guided into and out of the pad via the pole areas and forms an arch shaped loop in the space beyond the front or top surface of the pad to provide a significant “z” axis flux component at a significant height above the front surface of the pad.

The flux pipe between the coil apertures that magnetically links the two D coils and causes them to operate as if they formed one solenoid coil, with the exception that the coil apertures at each end are co-planar and both face upward (instead of being in separated planes at opposite ends of a single axis or line). An alternative analogy is that of a toroidal winding that has been cut in half to expose two co-planar pole faces and whose windings are flattened into that plane, where the inner portion of the windings between the two coil apertures sits over the region now called the flux pipe, and the remaining portions of windings surround the outer edges of the DD pad. Because flux paths are formed between the coil apertures through the flux pipe under the coils and out of each coil aperture, the shortest and thus lowest reluctance path to close the flux path is that formed over the flux pipe, and most importantly not by fringing around the outer edges of the pad and around the back as would be the case with a simple axial solenoid or single flat spiral coil (because the entry and exit coil apertures for the flux path in air both appear on the top side).

Yet another analogy is that the portion of the windings over the flux pipe region form the equivalent of one current carrying conductor, with associated flux path in a circle around that conductor. By placing ferrite below that current carrying conductor the flux path below the conductor is constrained within the ferrite. Above the ferrite the flux forms a path over the wire, and as such is concentrated above the wire (which is over the flux pipe region). Increased levels of current (or effective amp-turns) will produce more flux in the desired region over the wire (being the flux pipe region). This is in contrast to the conventional single coil that has to be considered as a pair of conductors in any cross-sectional view and carrying currents in opposite directions, with the consequence that flux paths are formed over both conductors. When ferrite backing is placed under such coils it also provides a low reluctance path for the fringing flux path formed outside of the perimeter of the coil and this reduces the amount or distribution of flux paths that are formed favorably above the center of the coil.

The DD pad thus forms flux paths constrained predominantly inside the perimeter of the two D coils. Adding magnetically permeable material (e.g., ferrite) to the “back” side of the pad has the effect of making the flux coupler one-sided (i.e., flux is predominantly constrained to the air facing surface rather than also forming paths extending below the back of the coupler). The two DD coils are driven (or wound) in anti-phase (e.g., out of phase by substantially 180 degrees) so that currents from the two windings flow in identical directions over the flux-pipe area with the consequence of doubling the magnetic flux in the region around these windings (e.g., above and through the flux pipe); since twice as much flux (as compared to that formed by one of the D coils) is formed over and through the flux pipe, these flux paths above the pad are distributed in the only space available which is that above the flux pipe, producing the desired increased elevation of flux distribution above the entire coil pad.

Another perspective on operation is that the adjacent inner windings of each of the DD coils effectively combine to produce twice as much aggregate flux that can only be distributed upward (more so than a standard circular coil since twice as much current is aggregated into this one region). This together with the flux pipe return path constrains almost all of the flux to the top air facing side, with much reduced leakage flux below or beside the pad (as would be the case for a single coil).

The inner DD winding portion 226 should be sufficiently densely packed (i.e., no substantial gaps) to avoid flux short-circuiting through to the flux pipe ferrite—i.e., to keep the flux path over the inner windings in the air and between the coil apertures and also to constrain the return flux path in the ferrite under the pad which forms the flux pipe.

An advantage compared to a single coil configuration is that the flux path on the top, air side is constrained inside the perimeter of the pad, and because of the aggregation of twice as much current passing over the flux pipe region it forms almost twice as much flux which naturally distributes itself over a greater z-axis height span.

In one or more embodiments the combined “DD” coil (or more accurately the perimeter shape formed by the combined DD coil) may be substantially orthogonally symmetric. In other words, there is not just substantial symmetry across one axis 218, but the same substantial symmetry exists in an orthogonal axis 220 as shown in FIG. 2. Or put differently: the two co-planar coils together define a shape which is substantially equally extended in orthogonal directions. Alternatively, the perimeter shape may have at least 4 lines of substantial symmetry 218, 220, 222, 224. Examples of such perimeter shapes include a square, circle, diamond/kite and other similar shapes.

In another alternative the length 230 of the inner winding portions 226 (measured in the y axis 218 of the plane of the first and second coils) in the flux pipe area is substantially similar to the width 232 across the combined DD coils, or the distance between the respective outer winding portions 228, (measured in the x axis 220 of the plane of first and second coils). This results in an overall shape that is substantially square, formed by two rectangular D coils side by side, producing an equal performance of coupling of a receiver to a transmitter in either y- or x-axis misalignments.

An example of substantial symmetry is that the perimeter formed by the outer portions 228 has an aspect ratio of between 0.8:1 and 1.2:1. That is to say that the width in the x axis is between 0.8 and 1.2 times the height in the y axis. This is intended to cover situations where the intention was to have symmetry in orthogonal directions, but that due to commercial or manufacturing constraints or manufacturing tolerances, precise symmetry is not obtained.

The DD coil described above may be used in a number of configurations according to the application requirements. In a transmitter implementation the DD coils may be connected or driven in anti-phase. This is shown in more detail in FIGS. 2b and 2c. The inverter 6 provides a single AC driving signal at an IPT frequency e.g., 110 kHz. The first coil 212 is wound clockwise, and is connected in series with the second coil 214 wound clockwise. Thus, the coils 212 and 214 are series connected, with a series tuning capacitor 230. This create a region of high current and flux density in the inner winding portions 226 above the flux trap. Alternatively, each coil may be wound the same way, but provided with a separate phase shifted driving signal, either from separate inverters or from different outputs of a single inverter circuit.

FIG. 3 shows a DDQ type coil consisting of two adjacent coils 312 and 314 and a planar quadrature “Q” coil 317 overlaying coils 312 and 314. DDQ type coils are particularly suited as receiver coils for use with DD type transmitter coils to achieve effective power transfer for large transmitter coil and receiver coil separation. However, a DDQ coil could also be used in a transmitter which switches between circular and DD, where the Q coil could be used as the circular coil.

In one or more embodiments the “Q” coil of a DDQ arrangement may be substantially orthogonally symmetric. In other words, there is not just substantial symmetry across one axis 318, but the same substantial symmetry exists in an orthogonal axis 320 as shown in FIG. 3.

Alternatively, the Q coil may have at least 4 lines of symmetry 318, 320, 322, 324. This gives the coils more omnidirectional coverage in the X-Y plane compared with the prior art DDQ pads which are intentionally polarized in this respect in order to allow for greater misalignment in the longitudinal axis. Known DDQ arrangements are always described as being rectangular. The Q coil in known arrangements is made of similar size to just one of the D coils, and not that of two D coils. The smaller size Q coil produces optimal magnetic coupling between it and one of the D coils when placed to couple with a DD pad.

One or more embodiments include a Q coil of a size that covers both of the D coils in the DD pad leads to misaligned system coupling performance that is equal in all translational directions within the plane of the coil pads. The Q coil encompasses the two D coils—i.e., there is no offset. In one example the Q coil is square with the two D coils being rectangular and sized to fit within (or coincide with) the Q coil. This provides a translationally omnidirectional response in the plane of the pad, and provides a commercially more useful shape (i.e., square rather than rectangular). The Q coil could also be a circular Q with semi-circular D coils, and diamond/kite like with triangular D coils.

When two such single sided flux couplers are misaligned, e.g., DD Tx with DDQ Rx, in the axis along the combined length of two D coils, the Rx output is provided sequentially by ‘DD’ over center, then ‘Q’ when offset by less than a D coil diameter, then by a single ‘D’ coil when offset by a whole D coil diameter. Conversely when misaligned in a y-axis along the run of wires forming the flux pipe (i.e., shorter axis of the DD pad), the coupling is provided entirely by the one combination of DD coils and relies on the width of the flux pipe in the y-axis to maintain a degree of coupling. By making that y-axis width of the flux pipe equal to the combined length of the DD pad in the x-axis, a roughly equal degree of misalignment performance can be obtained.

The DD coil or DDQ coil described above may be used in a number of configurations according to the application requirements. In a receiver implementation the DD coils are summed by connecting them in antiphase/opposite rotation of currents, the Q coil is added to the output of the DD coils. The DD coil output may be rectified and in series with the rectified output from the Q coil. It could equivalently be combined in parallel.

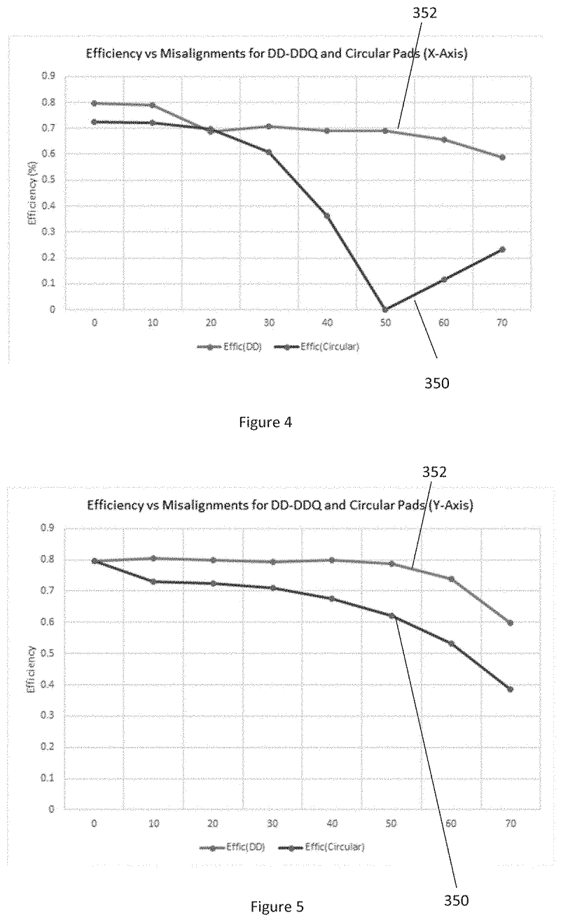

FIGS. 4 to 6 show experimental results of a DD Tx-DDQ Rx setup according to the embodiments above implemented in a circuit as shown in FIG. 7. The circuit 700 includes a transmitter with a H bridge full wave inverter 702 connected to an LCL tuned DD transmitter coil 704. The receiver includes a DD receiver coil 706 and a Q receiver coil 708. Both of the receiver coils are rectified 710 and the outputs connected in series to the load. While the DD transmitter coil 704 and DD receiver coil 706 are shown as a single coil they are in fact two adjacent, oppositely wound coils, connected in series, as described above.

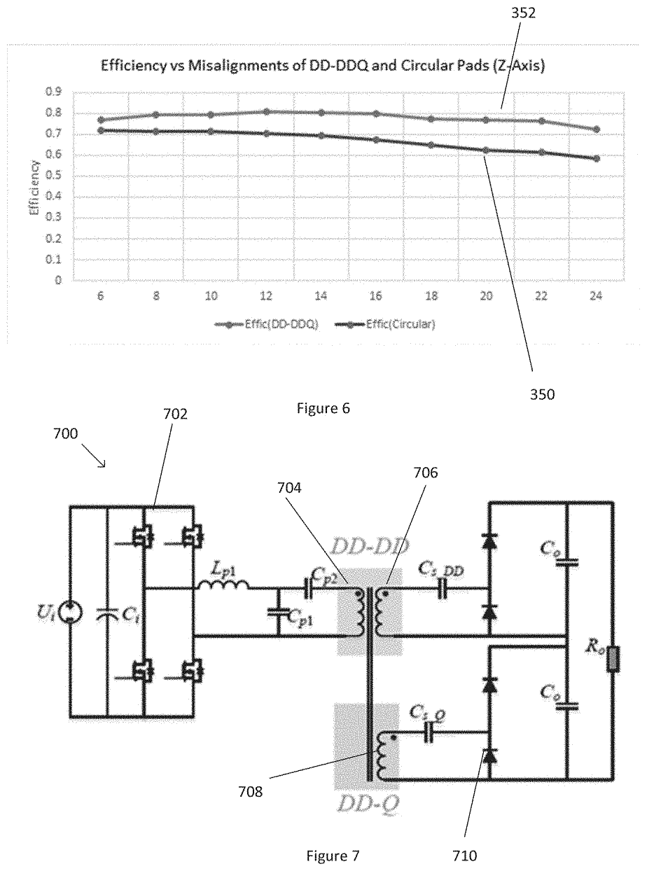

The performance of the symmetrical DD-DDQ system is compared to a standard prior art circular Tx and Rx coil system. The circular coil efficiency 350 is lower than the symmetrical DD-DDQ efficiency 352 for x axis misalignment in FIG. 4, y axis misalignment in FIG. 5 and z axis misalignment in FIG. 6. This shows that embodiments may provide improved misalignment performance in a range of axes.

An advantage of DD-DDQ Tx-Rx coil pairs compared with C-C (i.e., circular) Tx-Rx coil pairings is significantly stronger coupling to allow for greater z-height and also better x-y misalignment. However, a disadvantage is that they are rotationally sensitive—if there is a 90 degrees rotational misalignment, there is zero coupling between the DD and DDQ coil pairing.

In a further embodiment 400a (FIG. 8A) a first set of DD coils 402a may be overlaid with another set of DD coils 404a overlapping but rotated at 90 degrees. The core 406a is provided underneath, but encompassing the entire perimeter. In this scenario either set of DD coils may be used to couple, to avoid the problem with 90 degrees rotational misalignment providing no coupling.

In a still further embodiment an array of DD coils may be provided with a range of orientations to overcome the 90 degrees rotational misalignment providing no coupling. FIG. 8 shows an array 400 of DD transmitting coils in a tessellating pattern where adjacent DD coils are rotated 90 degrees with respect to each other—notionally vertical 402 and horizontal 404. The array allows selection of one of the DD coils irrespective of where a receiver device (e.g., DDQ) is positioned. The use of the alternating rotation pattern further allows the receiver device to be arbitrarily oriented (ie any rotation).

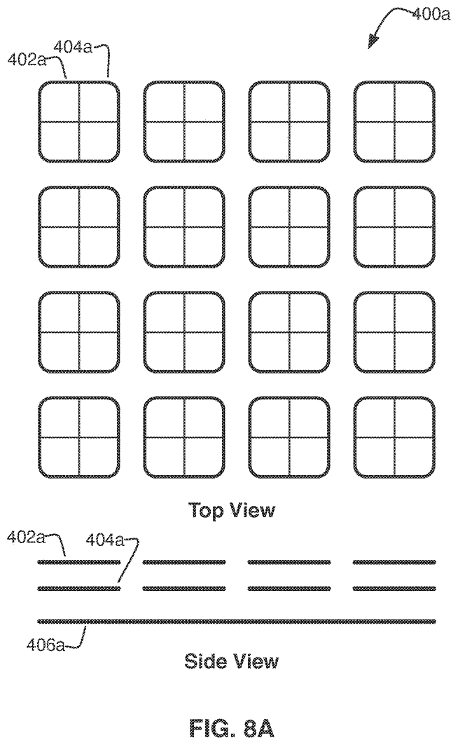

FIG. 9 shows the coverage pattern of a number of DD coils in the array. The coverage pattern may for example be the zone where 70% peak efficiency of a receiver coil is maintained at a z height of 24 mm. The “horizontal” DD coils 404 have a zone 504 around their respective DD coil, and the “vertical” DD coils 402 have a zone 502. These zones correspond to the flux coverage for a receiver device which is rotationally aligned with that coil—ie the receiver DDQ has the same rotational direction as the DD transmitter coil. Therefore, the combined coverage of the array where the Rx is rotationally aligned with the coil it would be coupled to is shown approximately by the rectangle 506.

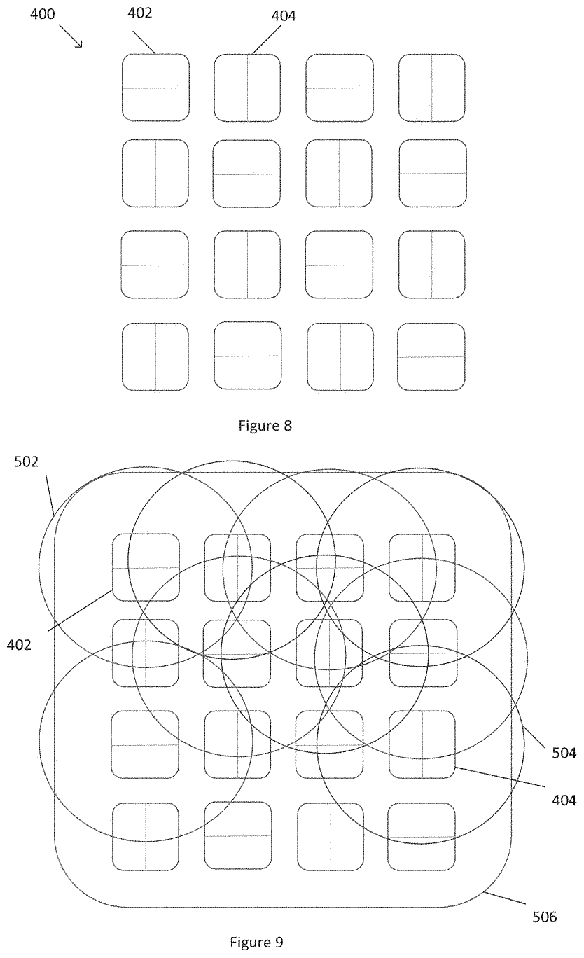

FIG. 10 shows the coverage pattern for receiver devices having a rotational orientation in the horizontal direction—ie they can couple with horizontal DD transmitter coils but not vertical DD transmitter coils. The combined coverage area is shown as the zone 606—and is smaller than the coverage where rotational alignment is not a factor (the rectangle 506 in FIG. 9).

FIG. 11 shows the corresponding coverage pattern for vertically oriented receiver devices, where the receiver device has a DD component to its coil (ie it is rotationally sensitive such as a DDQ coil). The combined coverage is shown by the zone 706—which is the same size as the zone 606 in FIG. 10 but rotated due to the different positioning of the vertical DD Tx coils.

The tessellating coil array having alternating rotationally oriented DD coils may allow the strong coupling advantage of the DD-DDQ pair whilst allowing for rotational insensitivity of the receiver arbitrary placement.

Various DD coil pair selections may be employed, for example a single DD coil pair depending on receiver location, or a combination of horizontally and/or vertically oriented coil pairs could be driven simultaneously. This could allow for user movement and/or rotation of the receiver with DDQ coil arrangement.

In a further arrangement, an array of DDQ coils could be employed where the DD and Q coils are driven simultaneously to mitigate the effect of rotational misalignment.

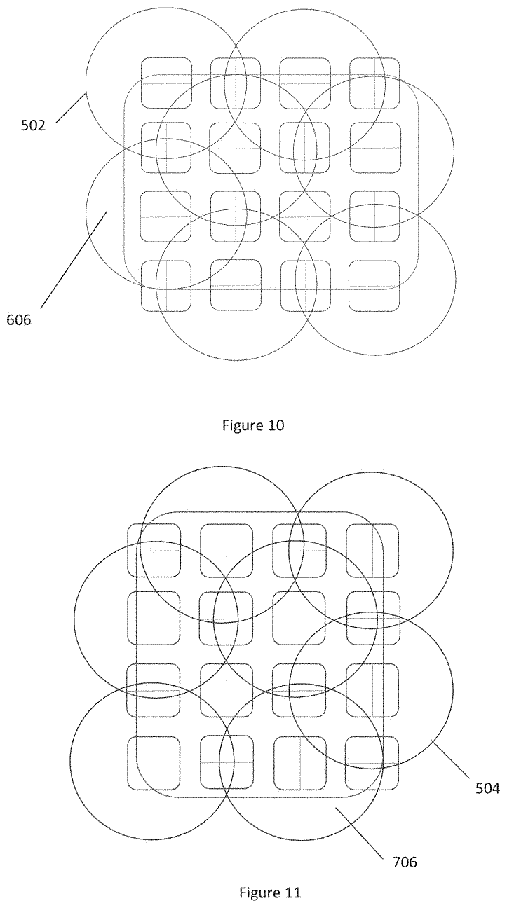

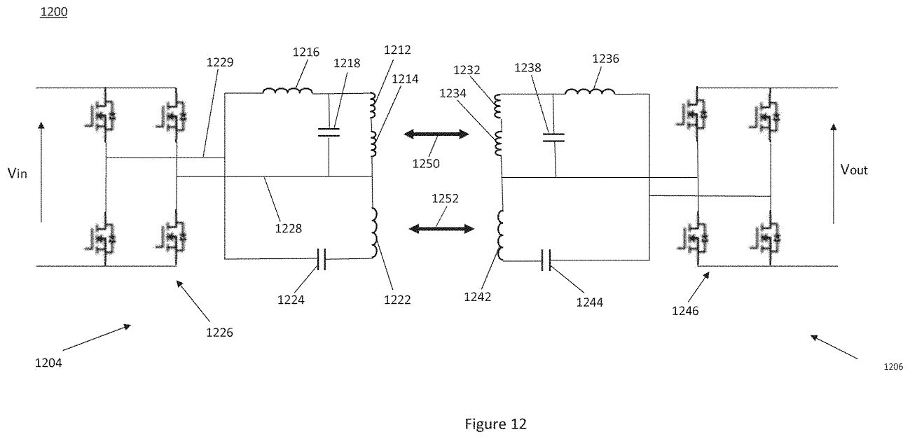

FIG. 12 shows a high-level circuit diagram of an inductive power transfer system according to some embodiments. The system 1200 comprises a transmitter shown generally as 1204 and which is magnetically coupled to a receiver shown generally as 1206. The transmitter 1204 and receiver 1206 both utilize two sets of coils coupled to respective compensation networks to provide a so called “hybrid tuning” arrangement as described in more detail in WO2017023180, the contents of which are hereby incorporated.

The transmitter 1204 includes an inverter 1226 which converts a DC input voltage Vin into an AC voltage. This AC voltage is supplied to a first compensation network comprising inductor 1216 and capacitor 1218 coupled to coils 1212 and 1214 configured in the previously described “DD” arrangement. The AC voltage from the inverter 1226 is also supplied to a second compensation network comprising capacitor 1224 coupled to coil 1222. This coil may be configured as the previously described “Q” coil of a combined DDQ coil arrangement, for example as shown in FIG. 3.

The two compensation networks 1216, 1218 and 1224 have different power transfer characteristics. In this implementation the upper or first compensation network 1216, 1218 is configured with the coils 1212, 1214 as a parallel tuned resonant circuit, in this case an LCL topology. The lower or second compensation network is configured with the coil 1222 and capacitor 1224 as a series tuned resonant circuit. Parallel and series tuned resonant circuits when used for inductive power transfer applications have different and in some ways complimentary characteristics so that using both provides improved power transfer capabilities. In addition, because the two compensation networks share an AC ground 1228 and AC high-side connections 1229, they can be driven by the same inverter 1226 thus reducing component count.

The receiver 1206 has complimentary coils and compensation networks, including coils 1232 and 1234 configured as the previously described “DD” arrangement, and coil 1242 configured as the previously described “Q” arrangement. Both coil sets 1232, 1234 and 1242 are coupled to respective compensation networks, which is turn are coupled to a common rectifier 1246. The upper or first compensation network comprising inductor 1236 and capacitor 1238 is configured with the coils 1232, 1234 as a parallel tuned resonant circuit, in this case an LCL topology. The lower or second compensation network 1244 is configured with the coil 1242 as a series tuned resonant circuit.

The coil sets (1212, 1214 and 1222, 1232, 1234 and 1242) of the transmitter and receiver are typically arranged to have minimal mutual coupling with the other coil set on the same device, so that they can couple more efficiently with their pairing coil on the other device. For example, as shown DD coils 1212 and 1214 of the transmitter are magnetically or inductively coupled with the DD coils 1232, 1234 of the receiver—this is indicated by line 1250. Similarly, the Q coil 1222 of the transmitter is coupled with the Q coil 1242 of the receiver. However, there is no or minimal mutual coupling between the DD and Q coils. As previously described the DD and Q coils are naturally decoupled because of their symmetric geometric configuration relative to each other, producing zero net flux linkage between them, and therefore this characteristic can advantageously be used in this embodiment. However other coil arrangements with minimal mutual coupling can be employed on the transmitter and/or receiver.

In the hybrid tuning arrangement of FIG. 12, the LCL (upper or first) compensation network and coils contribute more power for small displacements whereas the CL (lower or second) compensation network and coil transfers relatively more power at larger horizontal distances.

As will be appreciated by those skilled in the art, the capacitance and inductance values of the various coil and compensation network components will be optimized for their particular application, but may involve tuning both sides to a resonant or near resonant frequency for example.

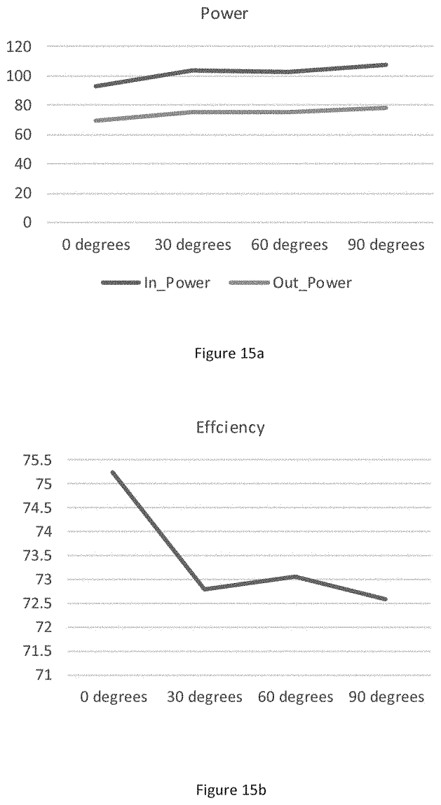

It has been found in practice that use of the circuit arrangement of FIG. 12 improves the rotational performance of the previously described DDQ-DDQ coil pairing arrangement. Whilst a rotational null might be expected when a DD-DD coil pairing are rotated 90 degrees with respect to each other, by adding the Q coils together with the hybrid tuning approach of FIG. 12, the rotational performance is surprisingly strong as illustrated in FIGS. 15a and 15b. FIG. 15a shows the power out compared with the power in for 0 to 90 degrees of rotation. FIG. 15b shows the efficiency of the system for 0 to 90 degrees of rotation, and it can be seen that whilst there is a small drop from 75.5 to 72.5, the efficiency at 90 degrees is still high less than a ten percent drop at a separation gap of 25 mm. Therefore, using this implementation, rotational misalignment has very little impact on the combined output power.

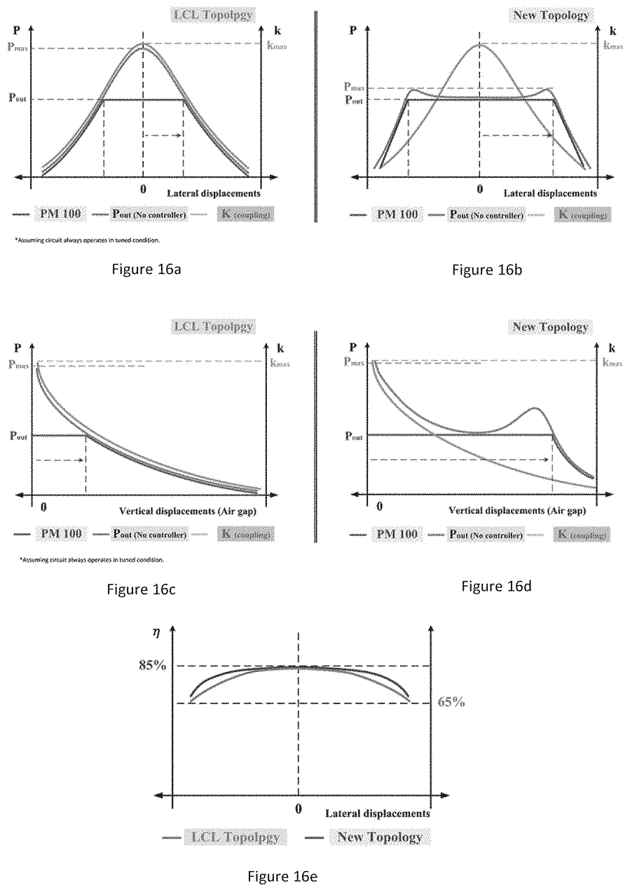

The circuit arrangement also provides improved spatial freedom, by extending the physical displacement from ideal alignment at which useful power can be transferred. Referring to FIGS. 16a-16e, simulated comparisons of a single LCL-LCL arrangement with the hybrid tuned arrangement of FIG. 12 are shown for various performance parameters. FIGS. 16a and 16c show lateral and vertical (i.e., z-height) displacement power transfer and coupling performance for the LCL-LCL arrangement (essentially the upper half of the hybrid tuned circuit of FIG. 12). FIGS. 16b and 16d show performance of the same parameters for the circuit of FIG. 12. As can be seen the misalignment tolerance in both dimensions has been considerably improved. FIG. 16e shows efficiency against lateral displacement for both topology types, and again the hybrid tuning arrangement of FIG. 12 shows some improvement.

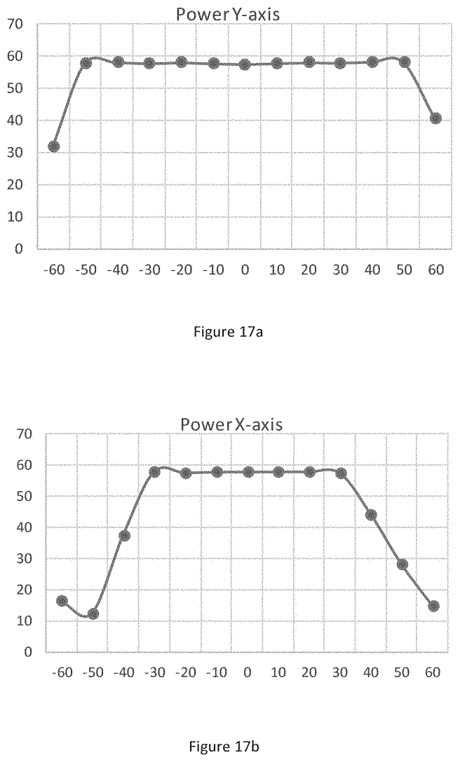

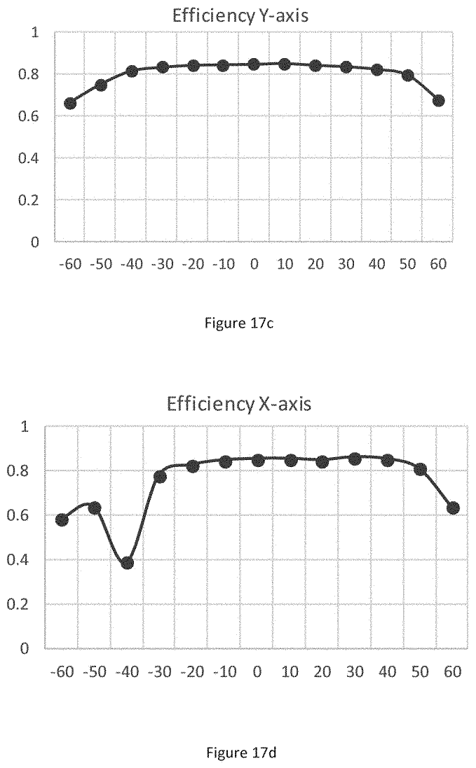

FIGS. 17a to 17d illustrate power and efficiency in the Y-axis and X-axis respectively for a prototype build according to the arrangement of FIG. 12. Again, relatively uniform power transfer is demonstrated across a wide range of lateral displacements.

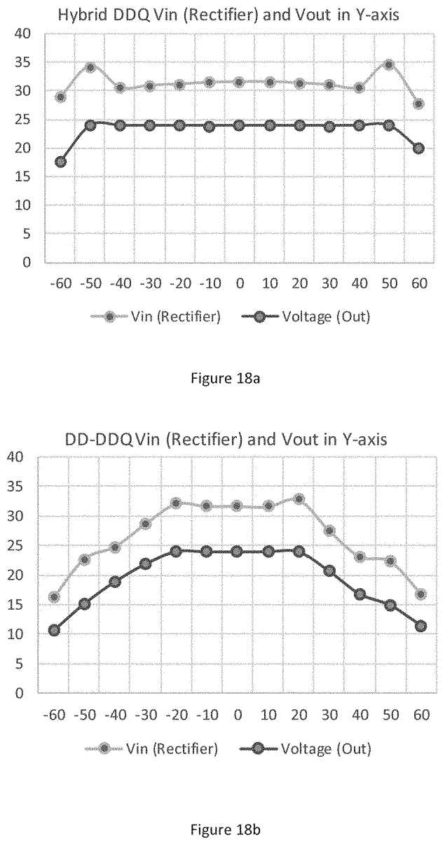

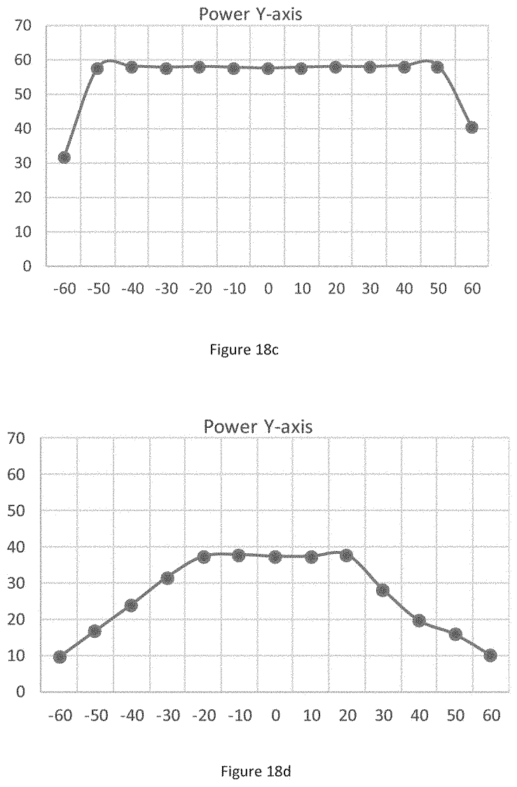

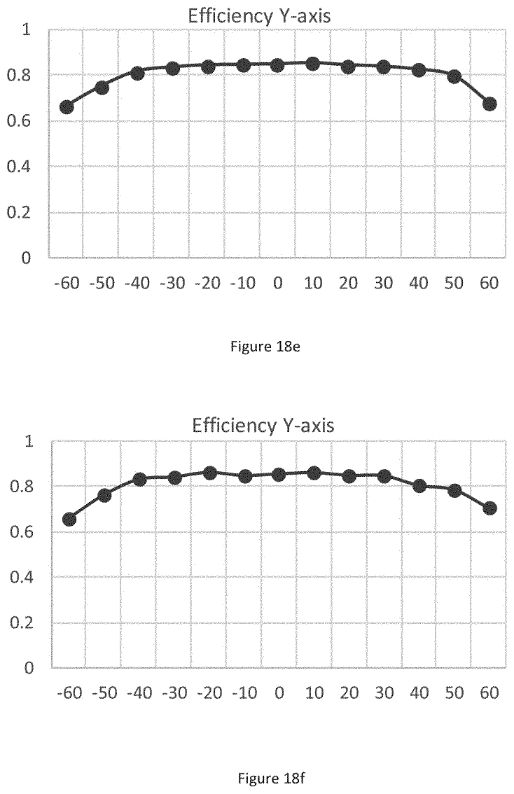

Finally FIGS. 18a-18f illustrate performance comparisons between the hybrid-tuning arrangement and the LCL only topology, both using DD coil arrangements. FIGS. 18a and 18b show Vi and Vout against displacement for the hybrid DD arrangement and the LCL DD arrangement respectively. FIGS. 18c and 18d show power transferred against displacement for the hybrid DD arrangement and the LCL DD arrangement respectively. FIGS. 18e and 18f show efficiency against displacement the hybrid DD arrangement and the LCL DD arrangement respectively. Again, significant performance improvements are provided by the hybrid DD arrangement of FIG. 12.

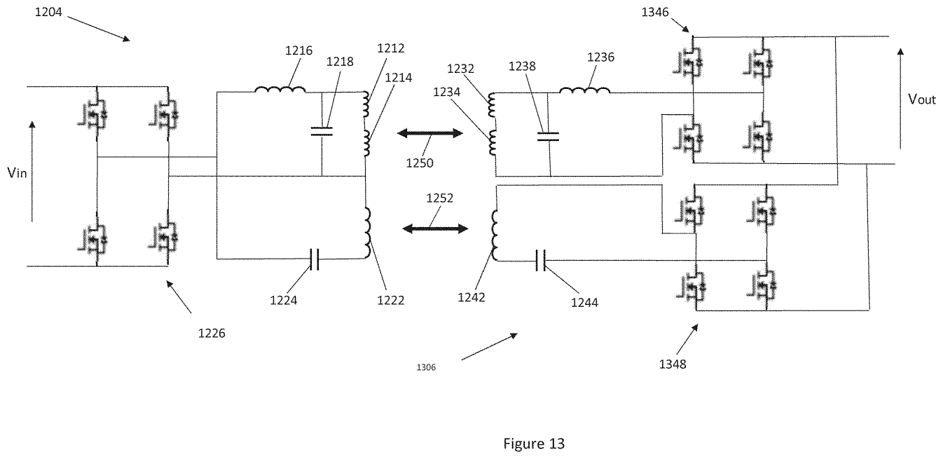

Referring now to FIG. 13, a modified version of the circuit of FIG. 12 is shown. Like parts are referenced the same. In the receiver 1306, separate rectifiers 1346 and 1348 are coupled to the first compensation network 1238, 1236 and the second compensation network 1244. The two compensation networks are essentially electrically decoupled and no longer share a common AC ground or high-side connection. Instead the outputs of the coils and compensation networks are separately rectified and combined on the DC side of the rectifiers. Whilst increasing the number of components, this arrangement does provide the advantage of improving rotational performance. As the DD coils 1232, 1234 of the receiver 1306 is rotated through 180 degrees with respect to the DD coils 1212, 1214 of the transmitter 1204, the phase of the induced current is inverted or 180 degrees out of phase compared with the induced current from the Q coil so that they oppose each other if combined in the AC domain. By instead combining these currents in the DC domain, after the rectifiers 1346 and 1348, only the magnitudes of the received voltages are combined therefore enhancing rotational performance through full rotation.

Various other alternatives or variations to the above described embodiments are contemplated. For example, the first compensation network may be series tuned and the second compensation network parallel tuned. The parallel tuned networks may be simple parallel capacitor arrangements instead of the LCL arrangements described. The described DD and Q coils may be swapped or may be replaced by alternative coil arrangements. Two sets of DD coils may be coupled to respective compensation networks, additionally these may be rotated with respect to each other—at 90 degrees they will be magnetically decoupled. The inverter and/or rectifier(s) may be half bridge or other know topologies rather than the full bridge arrangements shown. The two compensation networks may be tuned to different frequencies, for example slightly above and slightly below the operational frequency of the inverter. A split inverter arrangement may be used on the transmitter, complementary to the split rectifier arrangement of FIG. 13.

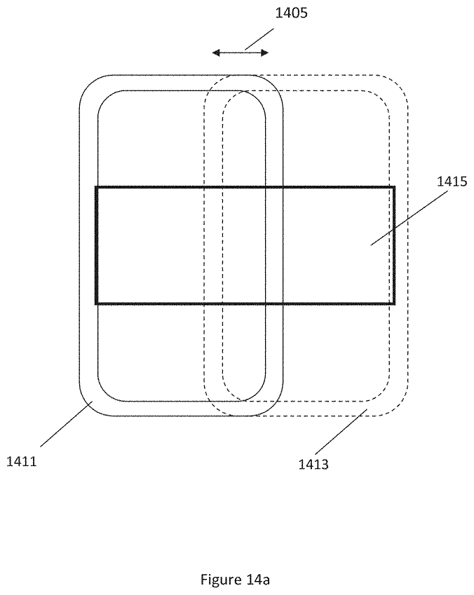

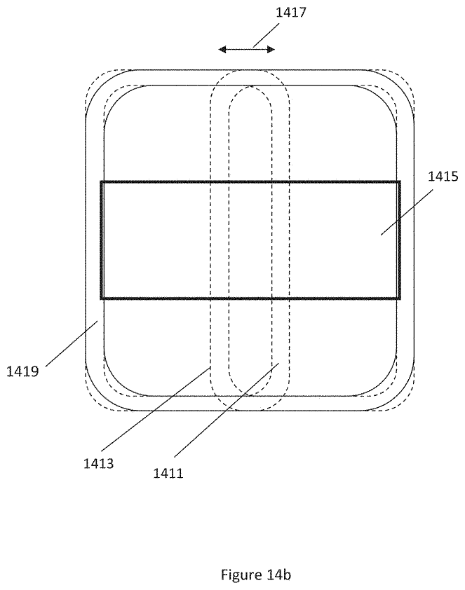

FIGS. 14a and 14b illustrate so called “bi-polar” coil arrangements originally described in WO2011016737, the contents of which are hereby incorporated. The arrangements of FIGS. 14a and 14b however, like the previously described DD coil arrangement, are symmetrical in two orthogonal axes. The bipolar coil arrangement 1405 of FIG. 14a comprises planar coils 1411 and 1413 (shown in dashed outline for ease of viewing) which overlap by an amount 1417 sufficient to minimize mutual coupling. This effect is described in more detail in the above referenced patent publication. The coil arrangement 1405 also comprises a magnetically permeable material 1415 onto which the coils are located, and which extends into both coil apertures, and constrains the flux generated (or received) by the coils in an inductive power transfer system, thereby reducing leakage flux and enhancing efficiency. The coils may be connected out of phase to a single inverter similar to the DD connection arrangement.

The coils 1411 and 1413 extend in one direction more than they extend in an orthogonal direction such that when they are combined they form a coil arrangement which is symmetrical in two orthogonal directions. In this example the coils are a rounded rectangular shape and together form rounded square shape. Other symmetrical shapes may be formed by the overlapping coils, for example circular and kite shaped. The coil arrangement 1405 may be employed in hybrid tuning circuits such as those of FIG. 12 or 13, replacing the DD coils 1212, 1214, 1232, 1234, or replacing the Q coils 1222, 1242. Two sets of bi-polar coil arrangements may alternatively be used, these may additionally be rotated with respect to each other.

FIG. 14b shows a variation of the coil arrangement of FIG. 14a, where an additional coil 1419 is added which follows the outer shape created by the two overlapping bi-polar coils 1411 and 1413. This is analogous to the Q coil previously described with respect to the DD coil arrangement. This additional coil 1419 may be coupled to one of the compensation networks of FIG. 12 or 13, while the bi-polar coils 1411, 1413 are coupled to the other compensation network.

There is also provided an inductive power transmitter or receiver comprising: a first planar coil and a second planar coil having substantially similar dimensions and arranged adjacent to each other on a first plane, the first coil having an inner winding portion extending immediately along-side a corresponding inner winding portion of the second coil, outer winding portions of the first and second coils forming a perimeter, and wherein the first and second coils define respective apertures; a third planar coil adjacent the first and second coils in a second plane parallel to the first plane, the third coil being substantially orthogonally symmetric or having at least 4 lines of substantial symmetry in the second plane; a magnetically permeable core extending between the apertures of the first and second coils.

There is also provided an inductive power transmitter or receiver comprising: a first planar coil and a second planar coil having substantially similar dimensions and arranged adjacent to each other on a first plane, the first coil having an inner winding portion extending immediately along-side a corresponding inner winding portion of the second coil, outer winding portions of the first and second coils forming a perimeter, and wherein the first and second coils define respective apertures, the shape of the perimeter is substantially orthogonally symmetric or has at least 4 lines of substantial symmetry in the first plane; a magnetically permeable core extending between the apertures of the first and second coils.

There is also provided an inductive power transmitter or receiver comprising: a first planar coil and a second planar coil having substantially similar dimensions and arranged adjacent to each other on a first plane, the first coil having an inner winding portion extending immediately along-side a corresponding inner winding portion of the second coil, outer winding portions of the first and second coils forming a perimeter, and wherein the first and second coils define respective apertures, and the length of the inner winding portion (measured in the y axis of the first plane) being substantially similar to the width of the perimeter (measured in the x axis of the first plane); and a magnetically permeable core extending between the apertures of the first and second coils.

There is also provided an inductive power transmitter or receiver comprising: a first planar coil and a second planar coil having substantially similar dimensions and arranged adjacent to each other on a first plane, the first coil having an inner winding portion extending immediately along-side a corresponding inner winding portion of the second coil, outer winding portions of the first and second coils forming a perimeter, and wherein the first and second coils define respective apertures; a third planar coil and a fourth planar coil adjacent the first and second coils in a second plane parallel to the first plane, having substantially similar dimensions and arranged adjacent to each other on the second plane, the third coil having an inner winding portion extending immediately along-side a corresponding inner winding portion of the fourth coil, outer winding portions of the third and fourth coils forming a perimeter, and wherein the third and fourth coils define respective apertures; a magnetically permeable core adjacent the first and second coils in a third plane parallel to the first plane; wherein the third and fourth coils are rotated 90° in the second plane relative to the first and second coils.

The third coil may be a Q or quadrature coil.

The first and second coils may be D coils, or DD in combination.

The third coil may be substantially square, circular, or diamond shaped.

The perimeter may be substantially square, circular, or diamond shaped.

The first and second coils may each be substantially rectangular, semi circular, or triangle shaped and the third coil is substantially square, circular, or diamond shaped.

The perimeter and the third coil may substantially coincide.

The third coil may be substantially omnidirectional in relation to the second plane.

The combination of the first and second coils may be substantially omnidirectional in relation to the first plane.

The density of the windings in the inner winding portion may be substantially more than the perimeter.

The aspect ratio of the combination of the first and second coils in the first plane may be between 0.8:1 and 1.2:1.

The aspect ratio of the third coil in the second plane is between is between 0.8:1 and 1.2:1.

The core may be a ferrite sheet extending to the perimeter at least an inner side of each aperture, or extending past the perimeter.

The inner winding portions may be sufficiently close to each other that substantially no flux passes to or from the core in the region between the apertures.

The transmitter or receiver may further comprise one or more inverters driving the first and second coils, wherein the first and second coils are driven or connected in antiphase, or in phase.

The transmitter or receiver may further comprise an inverter driving the third coil, wherein the third coil is driven alternatively to the first and second coils, or is driven simultaneously, but out of phase with, the first and second coils.

The third coil may be driven at a 90° phase difference compared to the first and second coils.

The current, in the inner winding portions, is in the same direction for the first and second coils.

The transmitter may be a DD configuration.

The receiver may be a DDQ configuration.

There is also provided an inductive power transmitter or receiver comprising: a coil array including a plurality of coplanar DD coils, wherein the DD coils have two or more relative orientations.

Each DD coil may have a perimeter shape that is substantially orthogonally symmetric or has at least 4 lines of substantial symmetry.

The perimeter shape may be a square, circle, kite or diamond.

The coverage area (e.g., 70% peak efficiency) overlaps more than 50% of the DD coils.

Each DD coil has an orientation which may vary by 90° from its neighboring coils.

Each DD coil may be driven such that flux coverage extends beyond the center of each adjacent DD coil.

The transmitter or receiver may further comprise a Q coil.

The Q coil may be driven alternatively to the DD coils, or is driven simultaneously.

The coil array is a transmitting coil array.

There is also provided an inductive power transfer device for transmitting or receiving magnetic flux, the device comprising: two overlapping coils arranged in parallel planes and adjacent a magnetically permeable core, wherein the overlap of the coils is arranged to minimize mutual coupling between the coils; the coils together defining a shape which is symmetrical in two orthogonal axes in a plane parallel to the coils; a first compensation network coupled to the two co-planar coils; a second compensation connected to a third coil; wherein the first and second compensation networks each have a different power transfer characteristic.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power transfer device for transmitting or receiving magnetic flux, the device comprising:
a DD-type coil, the DD-type coil further comprising:
first and second co-planar and adjacent coils defining respective apertures and having a magnetically permeable core located to at least partially overlap both apertures;
the first and second co-planar coils together defining a shape that is substantially equally extended in orthogonal directions;
a Q-type coil, the Q-type coil further comprising a third coil having an aperture encompassing the respective apertures of the first and second co-planar coils;
a first compensation network coupled to the DD-type coil; and
a second compensation network coupled to the Q-type coil;
wherein the first and second compensation networks each have a different power transfer characteristic.

2. The device of claim 1, wherein an aspect ratio of the defined shape is between 0.8:1 and 1.2:1.

3. The device of claim 1, wherein the two co-planar coils are connected such that the apertures form poles of opposite polarity.

4. The device of claim 1, wherein the two co-planar coils are connected or driven such that a current flows in opposite directions in each of the two co-planar coils respectively.

5. The device of claim 1, wherein the third coil is arranged to conform to the shape defining the first and second co-planar coils.

6. The device of claim 1, wherein the third coil is driven at a 90 degree phase difference compared to the first and second co-planar coils.

7. The device of claim 1, wherein one of the compensation networks is a parallel tuned resonant circuit and the other compensation network is a series tuned resonant circuit.

8. The device of claim 7, wherein the first and second compensation networks share an AC ground and a high-side connection.

9. The device of claim 1, wherein a first of the two co-planar coils having an inner winding portion extending immediately along-side a corresponding inner winding portion of a second of the two co-planar coils, outer winding portions of the two co-planar coils defining the shape of the two co-planar coils, the shape being substantially orthogonally symmetric or having at least four lines of substantial symmetry in a first plane.

10. The device of claim 9 wherein a density of the windings in the inner winding portion is more than the outer windings.

11. The device of claim 9 wherein the core is a ferrite sheet extending to the outer windings.

12. The device of claim 9, wherein a current in the inner winding portions is in the same direction for the two co-planar coils.

13. The device of claim 1 wherein the shape of the DD-type coil is substantially square, circular, or diamond shaped.

14. The device of claim 13 wherein each of the first and second co-planar coils making up the DD-type coil are each substantially rectangular, semi-circular, or triangle shaped.

15. An inductive power transmitter comprising:
a DD-type coil, the DD-type coil further comprising:
first and second co-planar and adjacent coils defining respective apertures and having a magnetically permeable core located to at least partially overlap both apertures;
the first and second co-planar coils together defining a shape that is substantially equally extended in orthogonal directions;
a Q-type coil, the Q-type coil further comprising a third coil having an aperture encompassing the respective apertures of the first and second co-planar coils;
a first compensation network coupled to the DD-type coil;
a second compensation connected to the Q-type coil;
wherein the first and second compensation networks each have a different power transfer characteristic; and
at least one inverter driving the first and second transmitter compensation networks.

16. The inductive power transmitter of claim 15 wherein:
at least one inverter driving the first and second transmitter compensation networks comprises a single inverter driving both transmitter compensation networks; and
the first and second transmitter compensation networks share an AC ground and a high side connection.

17. The inductive power transmitter of claim 15, wherein the two co-planar coils are connected such that the apertures form poles of opposite polarity.

18. The inductive power transmitter of claim 15, wherein the two co-planar coils are connected or driven such that a current flows in opposite directions in each of the two co-planar coils respectively.

19. The inductive power transmitter of claim 15, wherein the third coil is arranged to conform to the shape defining the first and second co-planar coils.

20. The inductive power transmitter of claim 15, wherein the third coil is driven at a 90 degree phase difference compared to the first and second co-planar coils.

21. The inductive power transmitter of claim 15, wherein one of the compensation networks is a parallel tuned resonant circuit and the other compensation network is a series tuned resonant circuit.

22. The inductive power transmitter of claim 15, wherein a first of the two co-planar coils having an inner winding portion extending immediately along-side a corresponding inner winding portion of a second of the two co-planar coils, outer winding portions of the two co-planar coils defining the shape of the two co-planar coils, the shape being substantially orthogonally symmetric or having at least four lines of substantial symmetry in a first plane.

23. The inductive power transmitter of claim 22 wherein a density of the windings in the inner winding portion is more than the outer windings.

24. The inductive power transmitter of claim 22 wherein the core is a ferrite sheet extending to the outer windings.

25. The inductive power transmitter of claim 22, wherein a current in the inner winding portions is in the same direction for the two co-planar coils.

26. The inductive power transmitter of claim 15 wherein the shape of the DD-type coil is substantially square, circular, or diamond shaped.

27. The inductive power transmitter of claim 26 wherein each of the first and second co-planar coils making up the DD-type coil are each substantially rectangular, semi-circular, or triangle shaped.

28. An inductive power receiver comprising:
a DD-type coil, the DD-type coil further comprising:
first and second co-planar and adjacent coils defining respective apertures and having a magnetically permeable core located to at least partially overlap both apertures;
the first and second co-planar coils together defining a shape that is substantially equally extended in orthogonal directions;
a Q-type coil, the Q-type coil further comprising a third coil having an aperture encompassing the respective apertures of the first and second co-planar coils;
a first compensation network coupled to the DD-type coil;
a second compensation connected to the Q-type coil;
wherein the first and second compensation networks each have a different power transfer characteristic; and
at least one rectifier coupled to the first and second transmitter compensation networks.

29. The inductive power receiver of claim 28 wherein the at least one rectifier coupled to the first and second receiver compensation networks comprises a first rectifier coupled to the first receiver compensation network and a second rectifier coupled to the second receiver compensation network.

30. The inductive power receiver of claim 28, wherein the two co-planar coils are connected such that the apertures form poles of opposite polarity.

31. The inductive power receiver of claim 28, wherein the two co-planar coils are connected or driven such that a current flows in opposite directions in each of the two co-planar coils respectively.

32. The inductive power receiver of claim 28, wherein the third coil is arranged to conform to the shape defining the first and second co-planar coils.

33. The inductive power receiver of claim 28, wherein the third coil is driven at a 90 degree phase difference compared to the first and second co-planar coils.

34. The inductive power receiver of claim 28, wherein one of the compensation networks is a parallel tuned resonant circuit and the other compensation network is a series tuned resonant circuit.

35. The inductive power receiver of claim 28, wherein a first of the two co-planar coils having an inner winding portion extending immediately along-side a corresponding inner winding portion of a second of the two co-planar coils, outer winding portions of the two co-planar coils defining the shape of the two co-planar coils, the shape being substantially orthogonally symmetric or having at least four lines of substantial symmetry in a first plane.

36. The inductive power receiver of claim 35 wherein a density of the windings in the inner winding portion is more than the outer windings.

37. The inductive power receiver of claim 35 wherein the core is a ferrite sheet extending to the outer windings.

38. The inductive power receiver of claim 35, wherein a current in the inner winding portions is in the same direction for the two co-planar coils.

39. The inductive power receiver of claim 28 wherein the shape of the DD-type coil is substantially square, circular, or diamond shaped.

40. The inductive power receiver of claim 39 wherein each of the first and second co-planar coils making up the DD-type coil are each substantially rectangular, semi-circular, or triangle shaped.
